(19) United States
(12) Patent Application Publication
(10) Pub. No.: US 2012/0127763 A1
(43) Pub. Date: May 24, 2012

(54) ELECTRIC POWER SUPPLY SYSTEM COMPRISING POWER MODULES COUPLED IN PARALLEL

(75) Inventors: Sergej Kalaschnikow, Wien (AT); Rodney Allen Myers, Loves Park, IL (US); Dennis Tolstrup Kristensen, Loves Park, IL (US)

(73) Assignee: Danfoss Drives A/S, Graasten (DK)

(21) Appl. No.: 13/297,517

(22) Filed: Nov. 16, 2011

Related U.S. Application Data
(60) Provisional application No. 61/416,524, filed on Nov. 23, 2010.

(51) Int. Cl. H02J 3/50; H02M 5/42; H02J 3/46

(52) U.S. Cl. 363/34; 363/65

(57) ABSTRACT

The present invention relates to an electric power supply system comprising at least two power modules coupled in parallel and comprising a first power module comprising a first control means adapted to control the operation of at least the first power module, and a second power module comprising a second control means adapted to control the operation of at least the second power module and wherein the power modules are configured to operate in a manner coordinated with other power modules, the operation of each power module including switching the power module on and/or off if demand so requires. The present invention further relates to a method for carrying out the present invention.

### CROSS REFERENCE TO RELATED APPLICATIONS

This application is entitled to the benefit of and incorporates by reference essential subject matter disclosed in Provisional Patent Application Ser. No. 61/416,524 filed on Nov. 23, 2010.

### FIELD OF THE INVENTION

The present invention relates to a power supply system comprising a plurality of power modules, such as power supply modules or active filters, coupled in parallel. In particular, the present invention relates to a power supply system to be inserted between a power grid and a power consumer. The power grid may be a single or a three-phase power grid. The power supply system according to the present invention is capable of activating or deactivating individual power modules in accordance with for example the amount of power to be delivered to the power consumer. By constantly adjusting the number of activated power modules the total amount of electrical losses and the level of electromagnetic noise generated by the power supply system may be significantly reduced.

### BACKGROUND OF THE INVENTION

Various types of modular systems, such as modular filter systems, have been suggested in the field of power electronics. For example, the company Asea Brown Boveri (ABB) has in the Pamphlet “Quality Power Filter—Active Filtering Guide” disclosed how a plurality of active filters can be arranged in a parallel configuration. In the filter system suggested by ABB a master active filter controls a number of slave active filters.

However, it is a disadvantage of the system disclosed by ABB that all slave active filters are switched on at all times. By having all slave active filters switched on in such a continuous manner the total switching losses in the filters, and the generated electromagnetic noise reach unnecessary high levels. Thus, when viewed from a loss and noise perspective, the filter system proposed by ABB can be further improved.

### SUMMARY OF THE INVENTION

It may be seen as an object of the present invention to provide a power supply system where electrical losses in the form of conduction losses and switching losses are reduced.

It may further be seen as an object of the present invention to provide a power supply system where electromagnetic noise, such as switching noise from controllable semiconductor switching elements, transmitted into an associated power grid is significantly reduced.

It may even further be seen as an object of the present invention to provide a redundant and thereby reliable power supply system.

It may even still further be seen as an object of the present invention to provide a modular power supply system where the number of active power modules is constantly adjusted in order to match, for example, the amount of electrical power to be delivered.

The above mentioned objects are complied with by providing, in a first aspect an electric power supply system comprising at least two power modules coupled in parallel with an associated power supply line, the electric power supply system comprising a first power module adapted to supply power to an associated power consumer, the first power module comprising a first control means adapted to control the operation of at least the first power module, and a second power module adapted to supply power to the associated power consumer, the second power module comprising a second control means adapted to control the operation of at least the second power module, wherein the power modules are configured to operate in a manner coordinated with other power modules, the operation of each power module including switching the power module on and/or off if demand so requires.

In a second aspect, the present invention relates to a method of operating an electric power supply system comprising at least two power modules coupled in parallel with an associated power supply line, the method comprising the steps of firstly providing an electric power supply system comprising a first power module adapted to supply power to an associated power consumer, the first power module comprising a first control means adapted to control the operation of at least the first power module, and a second power module adapted to supply power to the associated power consumer, the second power module comprising a second control means adapted to control the operation of at least the second power module, and, secondly, operating the power modules in a manner coordinated with other power modules, the operation of each power module including switching the power module on and/or off if demand so requires.

The terms power supply system and power module are to be interpreted very broadly in that these terms are not to be interpreted only as meaning power generating means involving, for example, a generator and suitable rectifiers and/or other converters for bringing the supplied electricity into a desired form. As a result of the above-mentioned broad interpretation a power module may be interpreted as, for example, a complete frequency converter, an active rectifier, an active front end or rear end of a frequency converter, an active filter, a power factor correction circuit etc. All these power modules may apply controllable semiconductor switching elements, such as thyristors, power transistors, such as insulated gate bipolar transistors (IGBT), for providing electric power to a power consumer in a desired form. The supply of power to the associated power consumer or the filtering of harmonic noise appearing on the power supply line may be provided by means of one or more of several modulation techniques which are well known in the art such as pulse width or pulse amplitude modulation techniques.

Thus, according to the first and second aspects of the present invention a power supply system comprising two or more power modules coupled in parallel is provided. Such a configuration provides a redundant and reliable power supply system.

It is a huge advantage of the present invention that by constantly ensuring that only a minimum number of power modules are active, electrical losses in the form of conduction losses and switching losses are reduced to a minimum. Even further, electromagnetic noise, such as switching electromagnetic noise originating from controllable semiconductor switching elements, transmitted into an associated power grid may be significant reduced.

The electric power supply system may further comprise one or more additional power modules coupled in parallel with the associated power supply line, and adapted to supply power to the associated power consumer, and wherein each of the one or more additional power modules are configured to operate in a manner coordinated with one or more other power modules, the operation of each additional power module including switching the itself on and/or off if demand so requires. In this way the electric power supply system may be custom designed in order to fulfil predetermined demands, such as maximum power to be delivered, a specific loss or noise level to be complied with, etc.

The electric power supply system may even further comprise a system wherein the first power module is a master power module, the master power module comprising master control means at least adapted to control one or more slave power modules, and the second power module is a slave power module, the slave power module comprising a control means adapted to communicate with the master control means of the master power module and wherein the slave power module is configured to be operated in response to its communication with the master control means of the master power module, the operation of the slave power module including switching the slave power module on and/or off if demand so requires.

In addition, each of the one or more slave power modules may comprise control means adapted to communicate with the master control means of the master power module. The one or more additional slave power modules may be configured to be operated in response to their respective communication with the master control means of the master power module, the operation of the one or more additional slave power modules including switching the one or more additional slave power modules on and/or off if demands so requires.

The terminology master/slave power module may not necessarily be static. Thus, a slave power module may be appointed master power module if, for example, a previous master power module fails or breaks down during operation. The new master power module may be appointed manually or automatically for example by a higher level control system. Operation without master power module is possible as well. In this case, the higher level control system has a master function or each power module has the ability to function as a master power module.

The master and slave power modules may be interconnected by a communication means such as a data or communication bus, such as a serial data bus. In this way the master power module is capable of controlling the operation of the slave power module, including switching the slave power module on and/or off so that the number of active power modules is appropriate for, for example, the amount of power to be delivered, a specific loss or noise level to be complied with, etc.

As previously stated, the plurality of power modules may comprise power modules such as one or more AC to DC rectifiers, said AC to DC rectifier forming a front end of a frequency converter, one or more DC to AC converters, said DC to AC converter forming a rear end of a frequency converter, one or more complete frequency converters, one or more active filters or one or more power factor correction circuits etc.

### BRIEF DESCRIPTION OF THE DRAWINGS

The present invention and its advantages will become more apparent, when looking at the following description of possible embodiments of the invention, which will be described with reference to the accompanying figures wherein:

FIG. 1 shows an embodiment of the present invention involving four active filters coupled in parallel,

FIG. 2 shows a second embodiment of the present invention involving four active filters coupled in parallel and a means of controlling the individual filters,

FIG. 3 shows the flow chart for a method of controlling the filters illustrated in the second embodiment,

FIG. 4 shows a third embodiment of the invention wherein a master/slave control method is used,

FIG. 5 shows the flow chart for the master/slave control method described in the third embodiment,

FIG. 6 shows a fourth embodiment of the invention involving four active filters coupled in parallel, and

FIG. 7 shows a fifth embodiment of the invention involving four active filters coupled in parallel.

FIG. 8 shows a sixth embodiment of the invention involving four active filters coupled in parallel.

While the invention is susceptible to various modifications and alternative forms, a specific embodiment have been shown by way of example in the figures and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE INVENTION

In its most general form, the present invention relates to a power supply system comprising two or more power modules coupled in parallel and thereby establishing a redundant and reliable power supply system. The power modules are controlled in a way which activates only the number of power modules which is appropriate for the amount of power to be delivered. By constantly ensuring that only a minimum number of power modules are active, electrical losses in the form of conduction losses and switching losses are reduced to a minimum. Even further, electromagnetic noise, such as switching noise from controllable semiconductor switching elements, emitted into an associated power grid may be significantly reduced. Various types of semiconductor switching elements are applicable. However, semiconductor switching elements such as thyristors, power transistors, such as IGBTs, are the most common type of semiconductor switching elements.

So far the present invention has been disclosed with reference to applying a plurality of power modules in a parallel configuration. However, the principle of the present invention also applies to, for example, active filters or power factor correction circuits coupled in parallel.

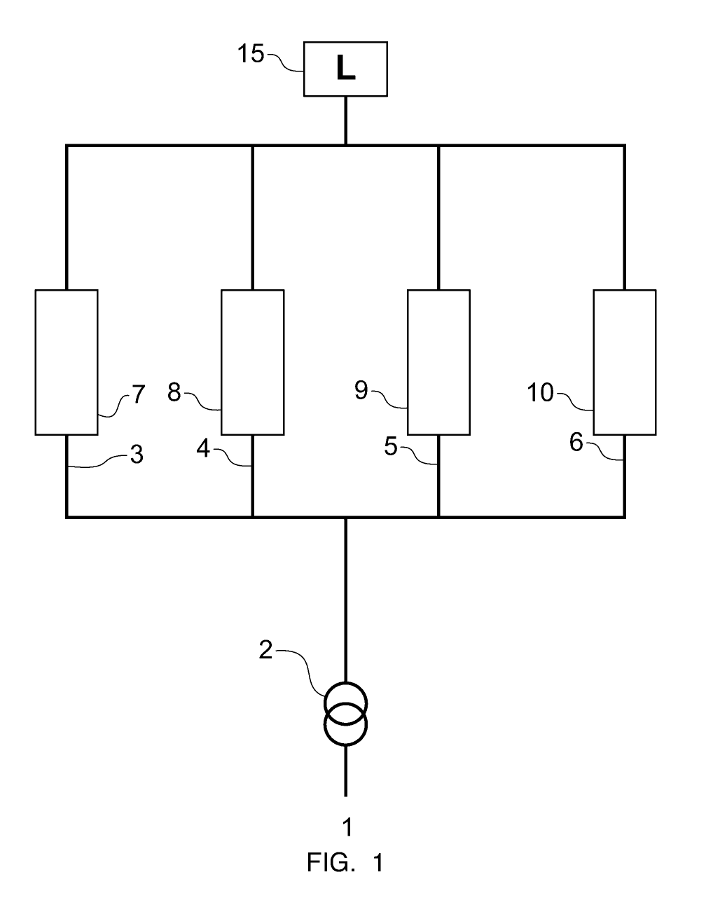

FIG. 1 shows an embodiment of the present invention involving, for example, four active filters coupled in parallel. However, the present invention is not limited to systems involving only active filters coupled in parallel. Thus, the active filters shown in FIG. 1 are only exemplary and could be replaced by complete frequency converters, active front ends of a frequency converter etc. without departing from the scope of the present invention.

As depicted in FIG. 1 the four active filters 7, 8, 9, 10 are inserted between a supply grid 1 and a power consumer 15. The harmonics or noise generated by the consumer, and consequently the work required from the active filters, varies with time, as is well known in the art. An optional grid transformer 2 has been inserted between the power grid 1 and the leads 3, 4, 5, 6 connected to respective ones of filters 7, 8, 9, 10.

Each of the active filters is individually capable of compensating for some of the harmonic noise power generated by the nonlinear power consumer, but not the maximum possible harmonic noise power. It is for this reason that four are connected in parallel in this embodiment. In prior art systems, as described above, this has the disadvantage of increased switching losses over a system with a single, larger capacity, active filter. However, in this embodiment of the invention, the four active filters are controlled in a manner in which only the appropriate number of active filters necessary for the amount of power to be delivered are switched on. For example, when the power required from the active filtering modules is a maximum, all the active filters are switched on and when only half the power from the active filtering modules is required, filters 9 and 10 are turned off, and filters 7 and 8 remain on. By constantly ensuring that only a minimum number of power modules are active, electrical losses in the form of conduction losses and switching losses are reduced to a minimum. Even further, electromagnetic noise, such as switching noise from controllable semiconductor switching elements, launched into an associated supply grid may be significantly reduced.

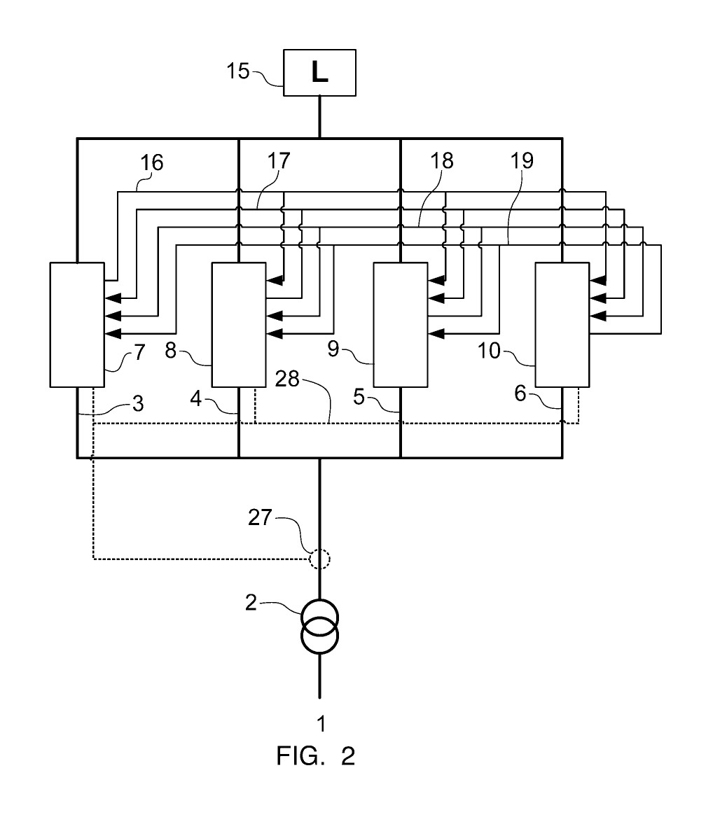

FIG. 2 shows a second embodiment of the present invention involving, for example, four active filters coupled in parallel. As described above, other types of module may be used. FIG. 2 also illustrates a means of controlling the individual filters.

As depicted in FIG. 2, the four active filters 7, 8, 9, 10 are inserted between a supply grid 1 and a power consumer 15. An optional grid transformer 2 has been inserted between the power grid 1 and the leads 3, 4, 5, 6 connected to respective ones of filters 7, 8, 9, 10.

The active filters 7, 8, 9, 10 are interconnected by several binary communication lines 16, 17, 18, 19 and by this means the active filters 7, 8, 9, 10 may communicate with each other and decide whether to be in ‘Run’ (‘Active’, ‘Turned on’ or ‘Alive’) mode or ‘Stop’ (‘Inactive’, ‘Sleep’, ‘Stop’ or ‘Turned off’) mode so that the number of active filters 7, 8, 9, 10 in ‘Run’ mode is maintained as appropriate for the amount of power to be delivered. By constantly ensuring that only a minimum number of active filters 7, 8, 9, 10 are in ‘Run’ mode, the advantages described above may be attained.

The binary communication line 16 conducts signals from the active filter 7 to the other active filters 8, 9, 10. Such a signal may be a high voltage (or ‘1’) representing the fact that the active filter 7 is in ‘Run’ mode and a low voltage (or ‘0’) representing the fact that the active filter 7 is in ‘Stop’ mode and is turned off, or any other means of communication well known in the art. The binary communication lines 17, 18 and 19 connect the other active filters 8, 9, 10 in a respective manner.

In this embodiment, all the active filters 7, 8, 9, 10 need to know or monitor the total system load. This is accomplished by use of a load or current measuring device 27 and the communication line 28 which supplies the load information to the individual active filters 7, 8, 9, 10. Since the active filters 7, 8, 9, are able to exchange information about their present modes by using the binary communication lines 16, 17, 18, 19 as described above, they are therefore able to control themselves without any external command. The control method will now be described.

Assuming that the power rating of each active filter 7, 8, 9, 10 has the same value, the reference R for output is calculated by each active filter using following formula:

$$R = \frac{L}{m}$$

where L is the present value of the total system load (obtained from the load or current measuring device 27 and supplied to the individual active filters 7, 8, 9, 10 via the communication line 28), and m is the number of active filters currently in ‘Run’ mode. The value of m is available to an individual active filter 7, 8, 9, 10 via the binary communication lines 16, 17, 18, 19. When in ‘Run’ mode, an individual active filter 7, 8, 9, 10 will reduce the harmonic noise content of the supply grid 1 by using up to a maximum power of R.

Assuming that the power rating of each active filter 7, 8, 9, 10 has the same value and each active filter is designated a number (nᵤ) from 1 to N (N being the total number of active filters) then the condition for each active filter change its mode to ‘Stop’ mode is:

$$L < ( \frac{P}{N} ( {n}_{u} - 1 ) - h ) \qquad ( 1 )$$

where P is the sum power capacity of all the active filters connected in parallel and is available to each active filter by being pre-programmed, N is the number of active filter connected in parallel and is available to each active filter by being pre-programmed, nᵤ is the designated number of the particular active filter (nᵤ=1, 2 . . . N) and h is a hysteresis value. Hysteresis can be used to filter signals so that the output reacts slowly by taking recent history into account.

The corresponding condition for a particular active filter to return to ‘Run’ mode is:

$$L > ( \frac{P}{N} ( {n}_{u} - 1 ) + h ) \qquad ( 2 )$$

The conditions (1) and (2) are continuously calculated by each active filter.

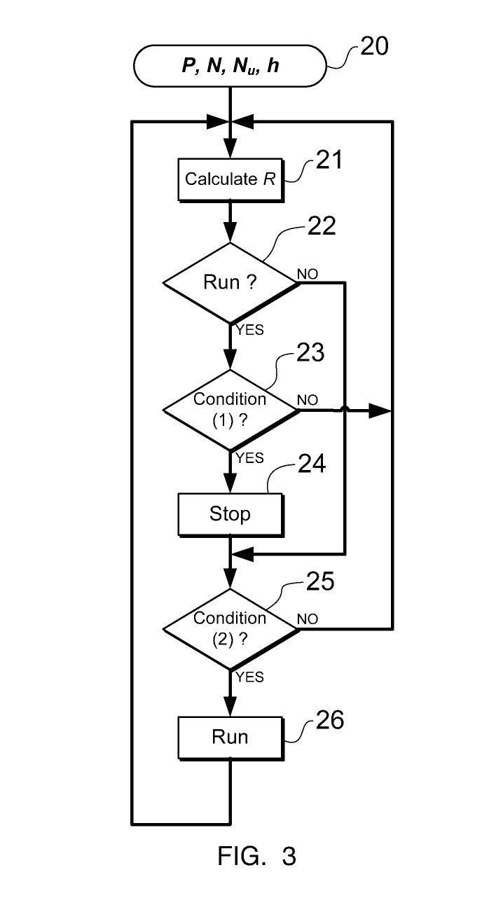

FIG. 3 shows the flow chart for the method described above. At startup 20 the pre-programmed values for P, N, nᵤ and h are read. The value of the reference R is calculated at 21 using the value of the present load L, obtained from the load or current measuring device 27. At the decision point 22 a jump is made to decision point 25, if the active filter is not in ‘Run’ mode, otherwise a decision is made at 23 depending upon the result of the condition (1) described above. If negative, that is if L is greater than

$$( \frac{P}{N} ( {n}_{u} - 1 ) - h ) ,$$

then the control passes to a recalculation of R at 21. If positive, then the active filter will go into ‘Stop’ mode at 24 and then calculate condition (2) at 25 to determine whether to return to ‘Run’ mode again.

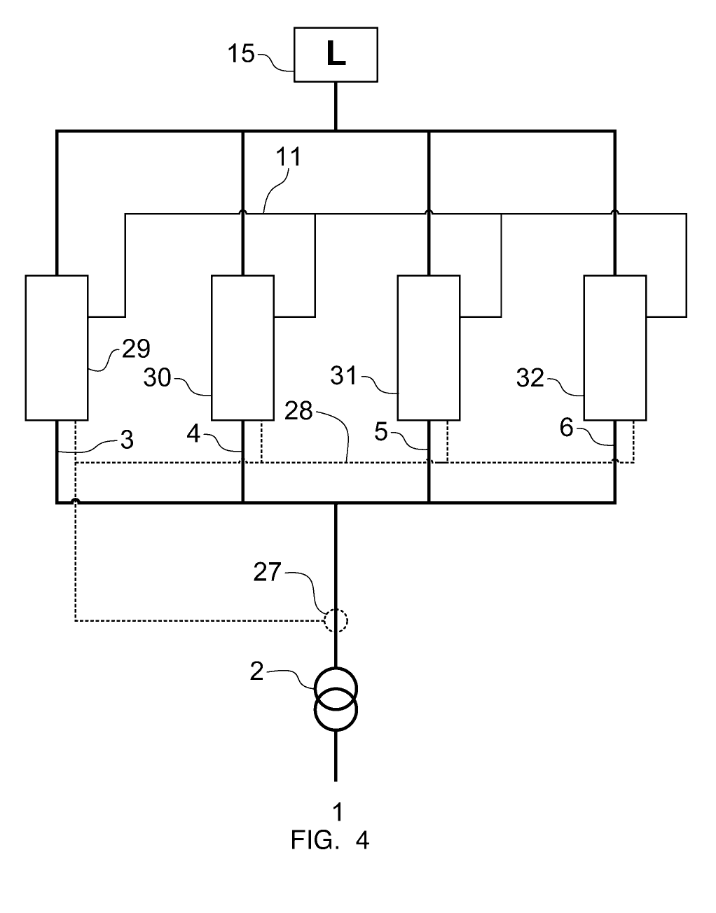

FIG. 4 illustrates a third embodiment of the invention wherein a master/slave control method is used, wherein one of the modules acts as a master power module whereas the other power module or modules act(s) as (a) slave power module(s). The power modules are interconnected by a communication means such as, for example, a serial data bus. In this way the master power module is capable of controlling the operation of the one or more slave power modules, including switching the slave power modules on and/or off so that the number of active power modules is appropriate for the amount of power to be delivered, with the resultant advantages that are described above.

With use of serial communication there is, in principle, no limitation to the number of control variables passed between the modules. The master power module can pass a control word containing such discrete values as ‘Start’, ‘Stop’, and ‘Standby’. The slave power module can respond with a status word containing such discrete values as warnings and alarms. This can be utilized by the master power module to determine and set which of the slave power modules performs the majority of the work to be done.

FIG. 4 shows, for example, four active filters 29, 30, 31 32 coupled in parallel. The four active filters 29, 30, 31, 32 are inserted between a supply grid 1 and a power consumer 15. An optional grid transformer 2 has been inserted between the power grid 1 and the leads 3, 4, 5, 6 connected to respective ones of the active filters 29, 30, 31, 32. One of the active filters, say active filter 29, is operated as a master active filter whereas the remaining active filters 30, 31, 32, are operated as slave active filters.

A communication means 11, such as, for example, a serial data bus, ensures appropriate communication between the active filters 29, 30, 31, 32, in particular between the master active filter 29 and the three slave active filters 30, 31, 32. Via this communication means 11 the master active filter 29, which may be controlled by a higher level control system, may control the operation parameters of all the slave active filters 30, 31, 32. Such operation parameters may, among other things, involve switching the slave active filters 30, 31, 32 on and/or off if demands so requires, or it may involve that a given slave active filter or a group of slave active filters should be operated in accordance with a predetermined set of operation parameters, such as a predetermined harmonic noise level, an amount of power to be delivered, the quality of the electrical power to be delivered etc.

Thus, it is an advantage of the present invention that the master active filter 29 may control the number of active slave filters 30, 31, 32 so that only the required number of slave filters are active, thus, achieving superior performance in terms of minimal losses and minimal noise generation.

The terminology master/slave may not necessarily be static. Thus, a slave filter may be appointed a new master filter if, for example, a previously appointed master filter fails or is taken offline. The new master filter may be appointed manually or automatically, for example by the higher level control system.

The number of master and slave filters may obviously differ from what is depicted in FIG. 4. Thus, a plurality of master filters may be provided. Similarly, the number of slave filters may differ from three as depicted in FIG. 4.

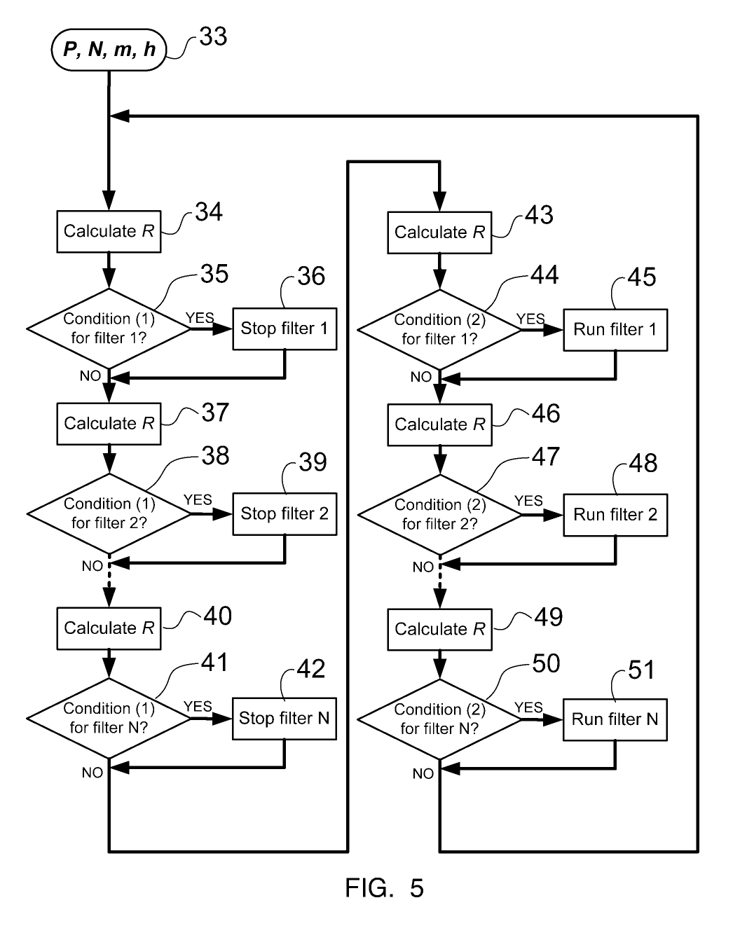

FIG. 5 shows the flow chart for the master/slave control method described in the third embodiment and illustrates the logical process followed by the control system of the master filter 29. The slave filters 30 31 32 are required in the embodiment merely to respond appropriately to ‘Run’ and ‘Stop’ mode commends from the master active filter 29, and to report relevant warnings and status messages.

At startup 33 the pre-programmed values for P, N, m and h are read. The present value of the reference R is calculated at 34 using the value of the present load L, obtained from the load or current measuring device 27 and m, the number of active filters currently in ‘Run’ mode. At the decision point 35 the equation (1) described above is calculated for the first active filter (nᵤ=1) and a decision is made as to whether to place the first active filter into ‘Stop’ mode 36, or to continue directly to a recalculation of the reference R at 37. At 38 equation (1) is calculated for the second active filter (nᵤ=2) and a decision is made as to whether to place the second active filter into ‘Stop’ mode 39, or to continue directly to a recalculation of the reference R. This process of calculating the current reference R, calculating equation (1) and stopping the respective filter continues until the last filter (nᵤ=N) is reached 40, 41, 42. A similar sequence is then performed using equation (2) this time, to assess whether the respective filters should be placed in ‘Run’ mode is made 43-51 and the sequence finally returns to a recalculation of R at 34.

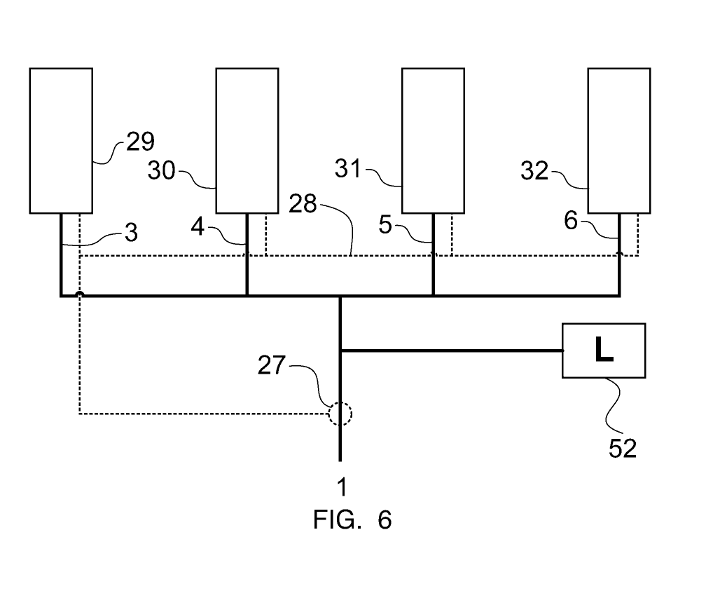

FIG. 6 shows a fourth embodiment of the invention involving four active filters coupled in parallel. The four active filters 7, 8, 9, 10 are connected to a supply grid 1 which also supplies a power consumer 52. The harmonic noise generated by the consumer, and consequently the work required from the active filters, varies with time, as is well known in the art. As described in the other embodiments above, each of the active filters is individually capable of compensating for some of the harmonic noise power generated by the nonlinear power consumer, but not the maximum possible harmonic noise power. As described above, the four active filters are controlled in a manner in which only the appropriate number of active filters necessary for the amount of power to be delivered to compensate for the harmonic noise generated are switched on. In this embodiment, all the active filters 7, 8, 9, 10 need to know or monitor the total system load. This is accomplished by use of a load or current measuring device 27 and the communication line 28 which supplies the load information to the individual active filters 7, 8, 9, 10.

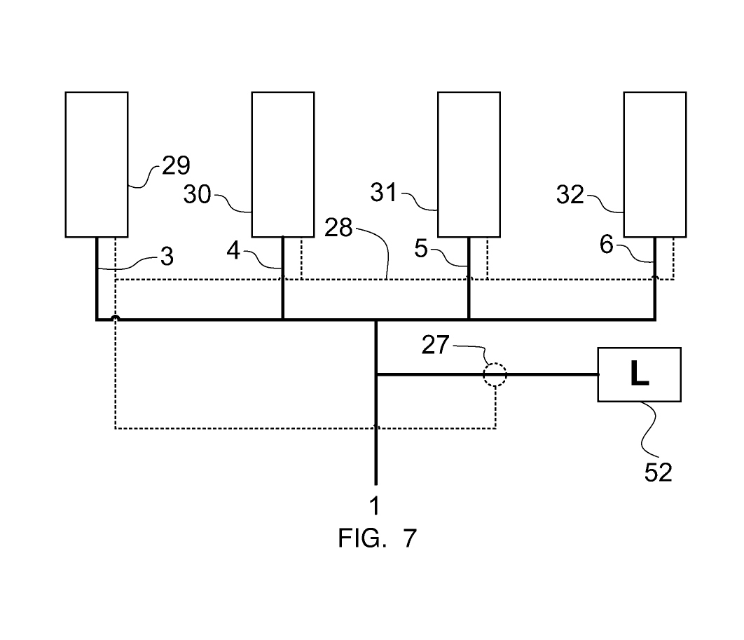

FIG. 7 shows a fifth embodiment of the invention involving four active filters coupled in parallel. This is similar to the embodiment illustrated in FIG. 6, but with the load or current measuring device 27 placed differently.

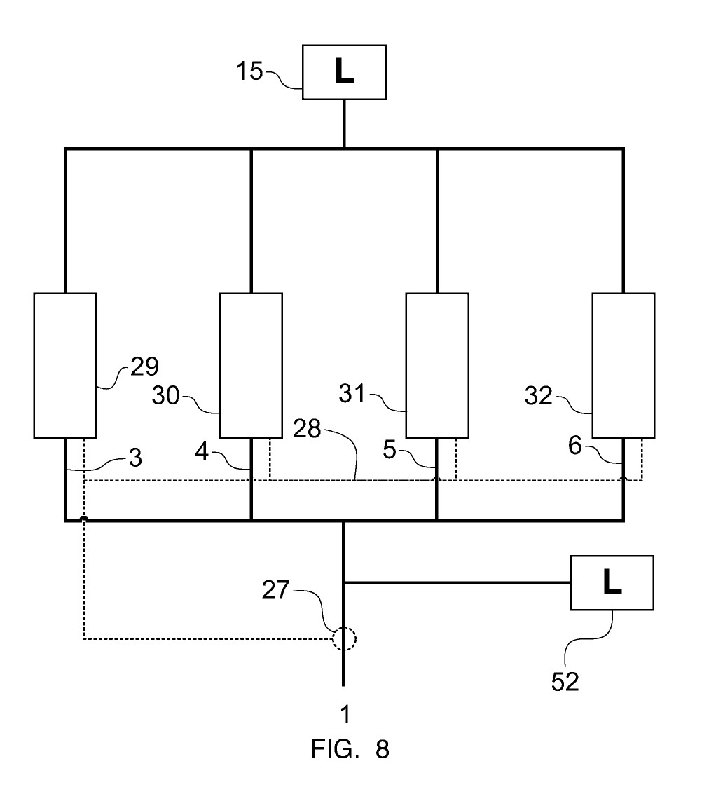

FIG. 8 shows a sixth embodiment of the invention involving four active filters coupled in parallel. This is similar to the embodiment illustrated in FIG. 6, but with the addition of a second load 15 which is supplied with power by the four parallel active filters 7, 8, 9, 10. Such an embodiment illustrates the fact that such active filters can simultaneously compensate for harmonic noise generated by loads connected as 52 or 15.

Although various embodiments of the present invention have been described and shown, the invention is not restricted thereto, but may also be embodied in other ways within the scope of the subject-matter defined in the following claims.

What is claimed is:

1. An electric power supply system comprising at least two power modules coupled in parallel with an associated power supply line, the electric power supply system comprising:
a first power module adapted to supply power to an associated power consumer, the first power module comprising a first control means adapted to control the operation of at least the first power module, and
a second power module adapted to supply power to the associated power consumer, the second power module comprising a second control means adapted to control the operation of at least the second power module,
wherein the power modules are configured to operate in a manner coordinated with other power modules, the operation of each power module including switching the power module on and/or off if demand so requires.

2. The electric power supply system according to claim 1, further comprising one or more additional power modules coupled in parallel with the associated power supply line.

3. The electric power supply system according to claim 2, wherein the one or more additional power modules are adapted to supply power to the associated power consumer, and wherein each of the one or more additional power modules are configured to operate in a manner coordinated with one or more other power modules, the operation of each additional power module including switching the itself on and/or off if demand so requires.

4. The electric power supply system according to claim 1, wherein
the first power module is a master power module, the master power module comprising master control means at least adapted to control one or more slave power modules, and
the second power module is a slave power module, the slave power module comprising a control means adapted to communicate with the master control means of the master power module
wherein the slave power module is configured to be operated in response to its communication with the master control means of the master power module, the operation of the slave power module including switching the slave power module on and/or off if demand so requires.

5. The electric power supply system according to claim 4, further wherein one or more of the additional power modules are additional slave power modules.

6. The electric power supply system according to claim 5, wherein each of the one or more slave power modules comprises control means adapted to communicate with the master control means of the master power module.

7. The electric power supply system according to claim 6, wherein the one or more additional slave power modules are configured to be operated in response to their respective communication with the master control means of the master power module, the operation of the one or more additional slave power modules including switching the one or more additional slave power modules on and off if demand so requires.

8. The electric power supply system according to claim 4, wherein communication between master and slave power modules is provided via a communication means, such as a data bus.

9. The electric power supply system according to claim 1, wherein a number of the at least two power modules comprise one or more of:
an AC to DC rectifier, said AC to DC rectifier forming a front end of a frequency converter,
a DC to AC converter, said DC to AC converter forming a rear end of a frequency converter,
a frequency converter.

10. The electric power supply system according to claim 1, wherein a number of the at least two power modules comprise one or more of:
an active filter and a power factor correction circuit.

11. A method of operating an electric power supply system comprising at least two power modules coupled in parallel with an associated power supply line, the method comprising the steps of:
providing an electric power supply system comprising
a first power module adapted to supply power to an associated power consumer, the first power module comprising a first control means adapted to control the operation of at least the first power module, and
a second power module adapted to supply power to the associated power consumer, the second power module comprising a second control means adapted to control the operation of at least the second power module,
operating the power modules in a manner coordinated with other power modules, the operation of each power module including switching the power module on and/or off if demand so requires.

12. The method according to claim 11, wherein the electric power supply system further comprises one or more additional power modules coupled in parallel with the associated power supply line.

13. The method according to claim 12, wherein the one or more additional power modules are adapted to supply power to the associated power consumer, and wherein each of the one or more additional power modules are configured to operate in a manner coordinated with one or more other power modules, the operation of each additional power module including switching the additional power module on and/or off if demand so requires.

14. The method according to claim 11, wherein
the first power module is a master power module, the master power module comprising master control means at least adapted to control one or more slave power modules, and
the second power module is a slave power module, the slave power module comprising a control means adapted to communicate with the master control means of the master power module
and the method further comprises operating the slave power module in accordance with its communication with the master control means of the master power module, the operation of the slave power module including switching the slave power module on and/or off if demand so requires.

15. The method according to claim 14, wherein the electric power supply system further comprises one or more additional slave power modules coupled in parallel with the associated power supply line.

16. The method according to claim 15, wherein the one or more additional slave power modules are adapted to supply power to the associated power consumer, and wherein each of the one or more slave power modules comprises control means adapted to communicate with the master control means of the master power module.

17. The method according to claim 16, wherein the one or more additional slave power modules are configured to be operated in response to their respective communication with the master control means of the master power module, the operation of the one or more additional slave power modules including switching the one or more additional slave power modules on and off if demand so requires.

18. The method according to claim 14, wherein communication between master and slave power modules is provided via a communication means, such as a data bus.

19. The method according to claim 11, wherein a number of the at least two power modules comprise one or more of:
an AC to DC rectifier, said AC to DC rectifier forming a front end of a frequency converter,
a DC to AC converter, said DC to AC converter forming a rear end of a frequency converter,
a frequency converter.

20. The method according to claim 11, wherein a number of the at least two power modules comprise one or more of:
an active filter and
a power factor correction circuit.
